(19) United States
(12) Patent Application Publication
(10) Pub. No.: US 2012/0303480 A1
(43) Pub. Date: Nov. 29, 2012

(54) Systems and Methods for an Electronic Shopping List

(75) Inventor: Carl Stone, Campbell, CA (US)

(73) Assignee: EBAY, INC., San Jose, CA (US)

(21) Appl. No.: 13/117,484

(22) Filed: May 27, 2011

(51) Int. Cl. G06Q 30/00

(52) U.S. Cl. 705/26.8

(57) ABSTRACT

Systems and methods are disclosed for an electronic shopping list running on a user device to aid a shopper. The electronic shopping list may obtain detailed information of products that match items on the list from inventory databases of one or more sellers. The shopper may use the product information to select the sellers and the specific products to purchase. Advantageously, the shopper may compare product information from multiple sellers. The electronic shopping list also keeps track of items from the list that have been purchased as the products are checked out. By checking off purchased products against items on the list, the electronic shopping list may remind the shopper when there are un-purchased items on the list before the purchase transaction is completed. Advantageously, from the alert, the shopper may select a product at the checkout counter for purchase and pick up the product after the purchase.

### TECHNICAL FIELD

The present disclosure relates generally to transactions conducted via a user device. In particular, the present disclosure relates to methods and systems for using an electronic shopping list on a user device to facilitate purchase transactions.

### BACKGROUND

A shopper frequently goes shopping with a shopping list of products to purchase. The shopping list may contain a general description of the products to purchase, but may lack information that allows the shopper to make decisions on the specific products to purchase. For example, the shopping list may not provide information on the availability, selection, and price of products sold by a merchant. Therefore, the shopper may not be able to select the specific products to purchase until the shopper is in the store looking at the products. The shopper also may not have product information from other merchants for the shopper to comparison shop between the merchants. In addition, it is cumbersome for a shopper to keep track of which products from the shopping list have been purchased and which products remain to be purchased. As a result, the shopper frequently does not realize that a product on the shopping list has not been purchased until the purchase transaction has been completed. Accordingly, there is a need for a better shopping list to simplify the shopping experience.

### BRIEF SUMMARY

Systems and methods are disclosed herein to provide an electronic shopping list running on a user device to aid a shopper. The electronic shopping list provides information of products on the shopping list from one or more merchants to help the shopper select specific products to purchase from the merchants. The electronic shopping list also checks off products that have been purchased from the shopping list and alert the shopper when there are products from the shopping list that have not been purchased.

In accordance with one or more embodiments of the present disclosure, a method for running an electronic shopping list application on a user device to aid a shopper is disclosed. The method includes creating an electronic shopping list containing items to purchase on the user device based on information received from a user. The method also includes the electronic shopping list determining products that are selected by the user at a seller location. The method further includes comparing the products selected by the user with the items on the electronic shopping list to determine the corresponding selected items on the electronic shopping list. The method further includes the electronic shopping list alerting the user of any items that are not selected on the electronic shopping list.

In accordance with one or more embodiments of the present disclosure, a user device is disclosed. The user device includes a processor and a memory that stores machine-readable instructions for execution by the processor to run a shopping list application. The user device runs the shopping list application to create an electronic shopping list containing items to purchase based on information received from a user. The user device also runs the shopping list application to determine products selected by the user at a seller location. The user device further runs the shopping list application to compare the products selected by the user with the items on the electronic shopping list to determine the corresponding selected items on the electronic shopping list The user device further runs the shopping list application to alert the user of any items that are not selected on the electronic shopping list.

In accordance with one or more embodiments of the present disclosure, a non-transitory computer readable medium having computer readable code for execution by a processor to perform a method is disclosed. The method includes creating an electronic shopping list containing items to purchase based on information received from a user. The method also includes determining products that are selected by the user at a seller location. The method further includes comparing the products selected by the user with the items on the electronic shopping list to determine the corresponding selected items on the electronic shopping list. The method further includes alerting the user of any items that are not selected on the electronic shopping list.

These and other embodiments of the present disclosure will be more fully understood by reference to the following detailed description of the embodiments when considered in conjunction with the accompanying drawings.

### BRIEF DESCRIPTION OF THE DRAWINGS

FIG. 1 shows a system for a user device running an electronic shopping list application to facilitate purchase transactions with a seller according to one or more embodiments of the present disclosure;

FIG. 2 shows a flow chart of the transactions on an electronic shopping list application running on a user device of FIG. 1 to obtain product information from a seller and to keep track of purchased products according to one or more embodiments of the present disclosure;

FIG. 3 shows a sequence of displays from an electronic shopping list application of a user device when a user makes product purchases at a first seller according to one or more embodiments of the present disclosure;

FIG. 4 shows a sequence of displays from the electronic shopping list application of the user device of FIG. 3 when a user makes product purchases at additional sellers according to one or more embodiments of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein for an electronic shopping list application running on a user device to aid a shopper in making purchases of products on the shopping list. The electronic list application may be provided by a payment service provider such as PayPal, Inc. of San Jose, Calif. The electronic shopping list may contain names of items or of general product categories. The electronic shopping list may obtain detailed information of items on the list from inventory databases of one or more sellers. The product information may include information such as brands, descriptions, and pricing of products that match items on the shopping list and that are available for purchase from the sellers. The shopper may use the product information to select the specific products to purchase and to select the seller from whom the products are purchased. Advantageously, the shopper may compare product information from multiple sellers to make a more informed purchase decision.

The electronic shopping list also keeps track of items from the list that have been purchased as the products are checked out at the checkout counter. By checking off purchased products from items on the list, the electronic shopping list may alert the shopper when there are un-purchased items on the list before the purchase transaction is completed. Advantageously, from the alert, the shopper may select a product at the checkout counter for purchase and pick up the product after the purchase. Therefore, the electronic shopping list simplifies the tasks of deciding specific products to purchase from one or more sellers for the shopper. It also reminds the shopper when the shopper forgets to purchase items on the shopping list before the purchase transaction is completed.

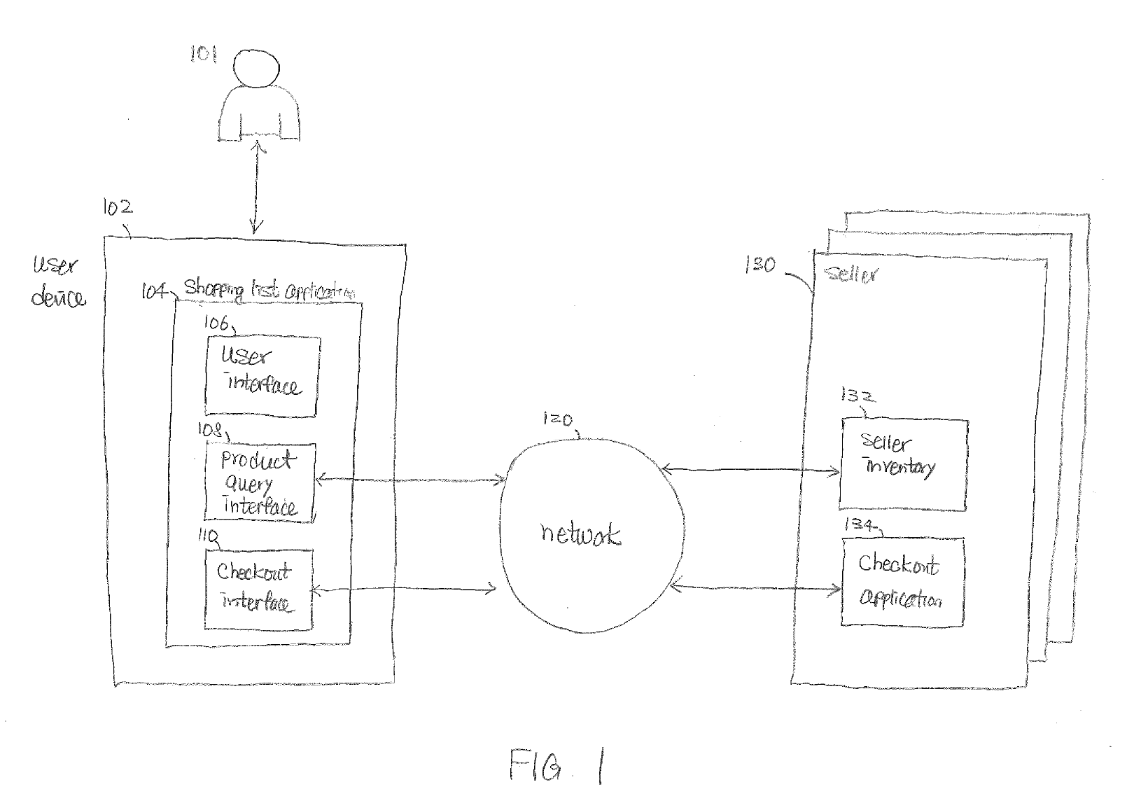

Refer now to the figures wherein the drawings are for purposes of illustrating embodiments of the present disclosure only, and not for purposes of limiting the same. FIG. 1 shows a system for a user device running an electronic shopping list application to facilitate purchase transactions with one or more sellers according to one or more embodiments of the present disclosure.

A user 101 uses a user device 102 to run a shopping list application 104 to conduct transactions with one or more sellers 130. Shopping list application 104 enables user 101 to create, view, organize, and manage the shopping list with information update from sellers 130. For example, user 101 may use shopping list application 104 to create a shopping list of items to purchase and to obtain detailed information of items on the shopping list from sellers 130. The detailed information enables user 101 to compare products from sellers 130 to help user 101 select specific products to purchase and the specific seller from which to make the purchase. User 101 may also use shopping list application 104 to automatically check off items that have been purchased and to be reminded about items that have yet to be purchased during checkout.

User device 102 that runs shopping list application 104 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. It should be appreciated that user device 102 may be referred to as a client device or a customer device without departing from the scope of the present disclosure. User device 102 may communicate over a network 120 with sellers 130.

Network 120 may be implemented as a single network or a combination of multiple networks. For example, in various embodiments, network 120 may include the Internet and/or one or more intranets, wireless networks (e.g., cellular, wide area network (WAN), WIFI hot spot, personal area network (PAN), Bluetooth), landline networks and/or other appropriate types of communication networks As such, in various embodiments, user device 102 may be associated with a particular link (e.g., a link, such as a URL (Uniform Resource Locator) to an IP (Internet Protocol) address).

Shopping list application 104 has a user interface 106, a product query interface 108, and a checkout interface 110. User interface 106 allows user 101 to interact with shopping list application 104 and to conduct transactions with sellers 130 over network 120. For example, user interface 106 allows user 101 to input the shopping list of items to purchase, and to view and manage the items and detailed information of the items on the shopping list. Inputting of items to purchase may be done in any number of ways. In one example, the user manually types in individual items or product types using a keypad or keyboard. In another example, the user may select items or product types from a list, such as a drop down menu of items/types available for purchase from a seller or items/types previously purchased by the user. If the user is planning on going to a specific store, the shopping list may include only those items or types available at that store. Creating the shopping list may include a combination of manual entry and product/type selection. In one embodiment, user interface 106 includes a software program, such as a graphical user interface (GUI), executable by a processor and configured to interface with user 101. User 101 may also use the GUI to access and browse product information of products that match one of the items on the shopping list where the products are available for purchase from sellers 130.

Product query interface 108 enables shopping list application 104 to obtain products information of items on the shopping list from sellers 130 over network 120. Product information of products in sellers' inventory is stored in a seller inventory database 132. When user device 102 comes within certain proximity of sellers 130, product query interface 108 may query seller inventory 132 of sellers 130 for products information of products available from sellers 130 where the products match one of the items on the shopping list. For example, in one or more embodiments, when user device 102 is in the vicinity of one of sellers 130, such as when user device 102 comes within approximately 500 yards of a store location of one of sellers 130, or when user 102 is within a range of a hotspot WiFi or a Bluetooth device etc. of one of sellers 130, product query interface 108 of user device 102 may query seller inventory 132 for product information of products matching items on the shopping list where the products are available for purchase from the seller. Here, network 120 may include the hotspot WiFi or the Bluetooth device of sellers 130 over which product query interface 108 communicates with sellers 130. Seller inventory 132 may match the queried items against products in its database, check for the availability of the products and provide product information to product query interface 108. Alternatively in other embodiments, user 101 may want to download product information from sellers 130 over network 120 even when user 101 is not in the vicinity of sellers 130. For example, product query interface 108 may query for product information of products matching items on the shopping list over the Internet from one or more sellers 130 that user 101 has designated. In addition, product query interface 108 may query seller inventory 132 to provide preferred pricing if user 101 belongs to a loyalty program of one of the sellers 130.

Product information of products matching items on the shopping list from seller inventory 132 may include brands, descriptions, and pricing information, etc. of the products. If the item on the shopping list is a general product category, the product information may include information on a selection of products that belong to the general product category. Seller inventory 132 may also provide information on discounts, promotions, specials, etc. on products matching items on the shopping list or may provide product information of products related to items on the shopping list. User 101 may view and compare product information from one or more sellers 130 through user interface 106. Based on the product information, user 101 may select the specific products to purchase from a seller and/or may purchase items on the shopping list from multiple sellers to get the best price and selection.

Once user 101 has selected the products to purchase and is ready to checkout, checkout interface 110 of shopping list application 104 may help shopping list application 104 keep track of items from the shopping list that have been purchased and may alert user 101 of any items remaining on the shopping list. For example, checkout interface 110 may communicate with a checkout application 134 from sellers 130 over network 120 to obtain information on purchased products. As the bar code or the radio frequency identification (RFID) of the products are scanned during checkout by sellers 130, product and price information on the purchased products are registered onto a sales receipt. Checkout interface 110 may query checkout application 134 of sellers 130 for info nation on the sales receipt to obtain information on the purchased products. Checkout interface 110 may check items on the shopping list against the purchased products on the sales receipt to identify items that have been purchased and items that remain to be purchased. Before the completion of checkout, if the shopping list contains any un-purchased item with one or more matching products that are available from the seller, user interface 106 may alert user 101 to the un-purchased item.

In one or more embodiments, user interface 106 may display the barcodes of the products matching the un-purchased items. User 101 may choose to purchase the un-purchased items by selecting and scanning the barcodes of the products before completing the checkout. User 101 may then pick up the purchased items after checkout. Thus, user 101 is alerted to un-purchased items from the shopping list and may conveniently purchase the items before completing checkout. In other embodiments, user 101 may be notified of any un-purchased items prior to initiating a checkout process. For example, a user may indicate that shopping is complete, and user device 102 may indicate to the user any un-purchased items from the shopping list. Determining which items are un-purchased may be done in any number of ways, including a scanner/reader in a cart or basket that reads in each product placed into the cart or basket and comparing the results with the shopping list.

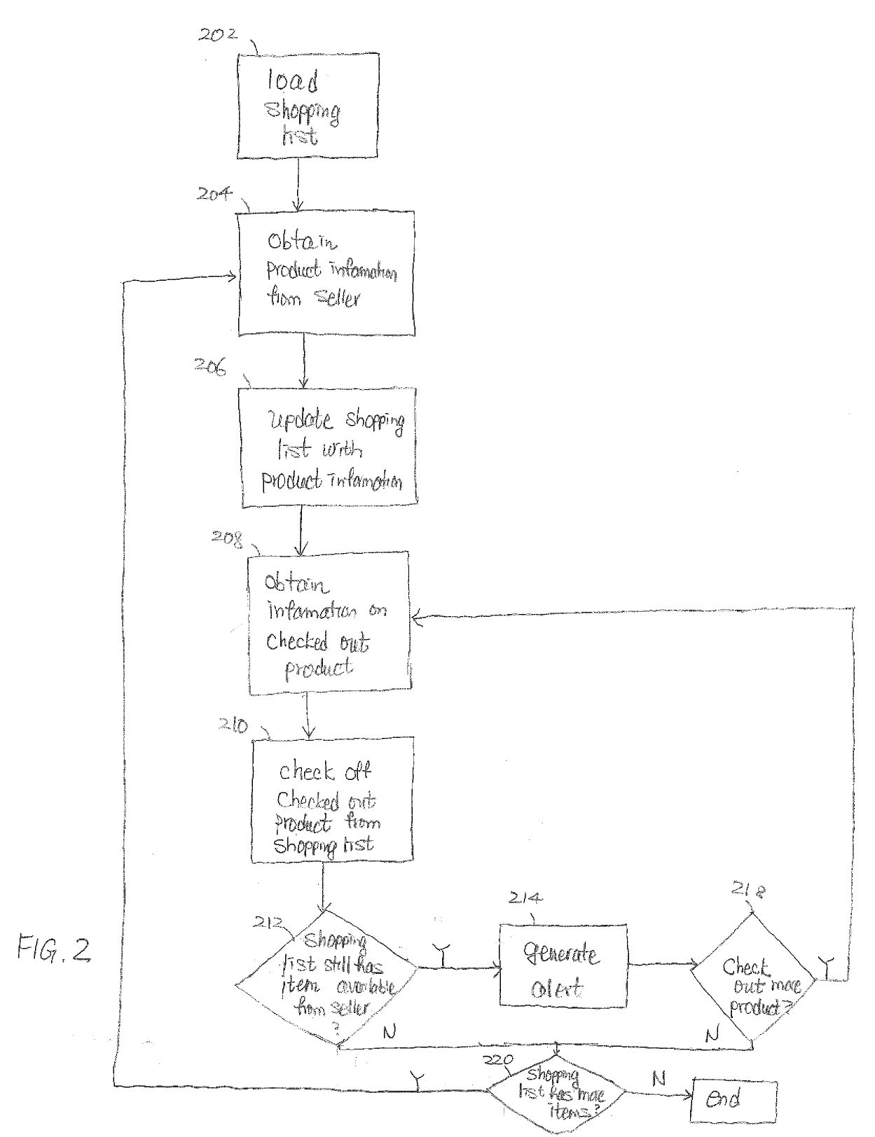

FIG. 2 shows a flow chart of the transactions on an electronic shopping list application 104 running on a user device 102 of FIG. 1 to obtain product information from a seller and to keep track of purchased products according to one or more embodiments of the present disclosure. In step 202, user 101 loads a shopping list of items into shopping list application 104 through user interface 106. For example, user 101 may type, or copy and paste a list of items to create a shopping list in shopping list application 104. Alternatively, user 101 may create a shopping list offline and upload the shopping list into shopping list application 104. User 101 may also select items from a list or a menu provided by the shopping list application. Items on the shopping list may include names of specific items and/or names of general product categories.

In step 204, shopping list application 104 queries and obtains product information of items on the shopping list from a seller over network 120. Shopping list application 104 may make queries and obtain product information through product query interface 108 to and from database of seller inventory 132 of one or more sellers 130. For example, shopping list application 104 may make queries when user device 102 detects that it is within certain proximity of sellers 130. Alternatively, shopping list application 104 may make queries to sellers 130 as designated by user 101. Seller inventory 132 may match the queried items against its database of available products and provide information of matching products to shopping list application 104. If the queried item is identified with enough specificity, such as a specific product of a specific brand, seller inventory 132 may simply provide price information of the item. If the queried item does not have enough specificity or is a general product category, seller inventory 132 may provide product information on a selection of products that match the item or the general product category. In addition, if user 101 belongs to a loyalty program of a seller, shopping list application 102 may query the seller for preferred pricing under the loyalty program. Seller inventory 132 may also provide information on discounts, promotions, etc. for the queried items and/or suggest related products, and provide product information on the related products.

In step 206, shopping list application 104 is updated with the product information from sellers 130. In one or more embodiments, user interface 106 may organize items on the shopping list by sellers 130 so that user 101 may view products that match any items on the shopping list offered by a seller. For example, user interface 106 may organize the items so that user 101 may click on an item grouped under a seller to view detailed information of one or more products from the seller matching the selected item. The detailed information may include brand, description, price, etc. of the one or more products. Alternatively, for ease of comparison between same products offered by more than one seller, when user 101 clicks on an item, user interface 106 may display detailed information on a selection of products from all the sellers matching the selected item. User 101 may, based on the product information from the multiple sellers, select specific product to purchase and the seller from whom to purchase the products. In one or more embodiments, user 101 may select the products and sellers on shopping list application 102. Thus, user interface 106 may display under a seller products that user 101 has selected for purchase from the seller and items with matching products that user 101 has not selected but are available for purchase from the seller.

Once user 101 has selected the products to purchase from a seller, user 101 may proceed to checkout or purchase the products. In step 208, as products are scanned and registered onto a sales receipt, shopping list application 104 may obtain information on the purchased products to check off against the shopping list. Shopping list application 104 may use a checkout interface 110 to obtain information of the purchased products from a checkout application 134 of a seller over network 120. Information may include the same detailed information provided by sellers 130 in step 204, may contain a subset of the information presented in step 204, or may contain additional information. The purchased products may correspond to items on the shopping list or may not have matching items if user 101 has selected products to purchase that are not on the shopping list.

In step 210, if the purchased product corresponds to an item on the shopping list, the item is checked off from the shopping list. The purchased products may correspond to products that user 101 has specifically designated for purchase from the seller on shopping list application 102 in step 206, or may correspond to products that are available for purchase from the seller but have not previously been designated for purchase. Items that have been checked off as having been purchased may be designated as such in the shopping list. Thus, the shopping list may display under a seller items purchased from the seller and items with matching products available for purchase from the seller but not yet purchased. Alternatively, products selected by user 101 for purchase may be checked against items on the shopping list before the initiation of the checkout process. For example, products placed in a cart or basket may be scanned by a scanner/reader placed in the cart or basket and compared against items on the shopping list when user 101 indicates that shopping is completed. Shopping list application 102 may notify user 101 if there are items with matching products or specific products designated for purchase on the shopping list that are not in the cart or basket.

In step 212, before the completion of checkout, shopping list application 104 may check to see if there is any remaining item with matching products from the seller that has not been purchased, or if there is any specific product designated for purchase from the seller that has not been purchased. If there is, shopping list application 104 may generate an alert in step 214. Shopping list application 104 may display the items or products not purchased from the seller. In one or more embodiments, shopping list application 104 may display or contain checkout identification information of un-purchased products. For example, shopping list application 104 may display barcodes or contain near field communication (NFC) ID of products matching the un-purchased item or the specific product designated for purchase. User 101 may thus be reminded of items or products from the shopping list that user 101 has forgotten to purchase. In step 218, if user 101 decides to make additional purchases, user 101 may select an item or product from the shopping list and scan its barcode or NFC ID at checkout to make the purchase. Information on the purchased product is obtained by shopping list application 104 in step 208 and checked off from the shopping list in step 210. If there are still any remaining items or products for purchase from the seller, shopping list may continue to generate alerts until all the items or products available for purchase from the seller have been purchased or when user 101 decides to complete the checkout in step 218. In step 220, if after the checkout is complete the shopping list still contains any un-purchased items, user 101 may go to another seller and steps 204 to 218 are repeated for the un-purchased items from the additional seller. Thus, user 101 may purchase items on the shopping list from one or more sellers until all items have been purchased.

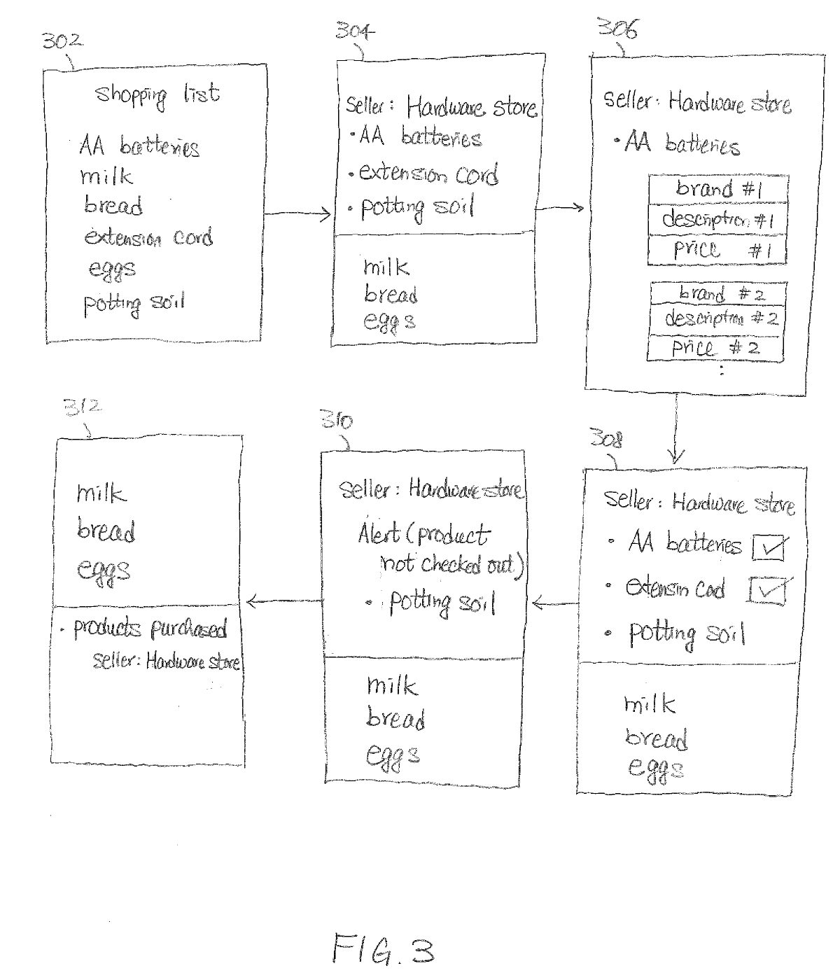

FIG. 3 shows a sequence of displays from electronic shopping list application 104 of user device 102 when user 101 makes product purchases at a first seller according to one or more embodiments of the present disclosure. In display 302, user 101 creates a shopping list of items in shopping list application 104 as in the step of 202 of FIG. 2. The shopping list contains specific items such as AA batteries and also general product categories of items such as milk, bread, extension cord, eggs, and potting soil. Note that the shopping list contains both grocery items to be purchased from grocers and general household items to be purchased from hardware stores.

When user device 102 is within certain proximity of a hardware store, shopping list application 104 queries seller inventory 132 of the hardware store for product information of items on the shopping list as in step 204 of FIG. 2. Seller inventory 132 searches through its database of products and provides product information on AA batteries, extension cord, and potting soil that are available for purchase to shopping list application 104. Shopping list application 104 updates the shopping list with the product information from the hardware store as in step 206 of FIG. 2. Display 304 shows that shopping list application 104 organizes the items by sellers and displays AA batteries, extension cord, and potting soil under the hardware store heading. User 101 may select an item displayed under the hardware store heading to obtain detailed information on products matching the selected item from the hardware store. For example, if user 101 selects AA batteries, display 306 shows brand, description, and price information for a selection of AA batteries from the hardware store. For an item listed on the shopping list as a general product category, the number of products matching the item and the amount of product information displayed may be greater than those displayed for an item specified with greater specificity. For example, if user 101 selects extension cord, shopping list application 104 may display product information for a selection of extension cords of different length, power rating, intended applications, etc. User 101 views the product information and may select a product for purchase by picking up the product from the hardware store. For example, user 101 may pick up AA batteries and an extension cord on the basis of the product information. User 101 may also designate on shopping list application 104 specific products to purchase as a reminder. For example, user 101 may designate on display 306 that user intends to purchase AA batteries from brand #2.

User 101 may proceed to checkout or purchase the AA batteries and the extension cord from the hardware store. As the AA batteries and the extension cord are scanned and registered onto a sales receipt, shopping list application 104 may obtain information on these products from checkout application 134 of the hardware store as in step 208 of FIG. 2. Shopping list application 104 matches the AA batteries and the extension cord with the corresponding items on the shopping list and checks off these items from the shopping list as in step 210 of FIG. 2. Display 308 shows that items for AA batteries and extension cord have check marks next to them to indicate that these items have been purchased from the hardware store. Purchased items may also be indicated in other ways. User 101 may select the AA batteries or extension cord on display 308 to view product information on these products received from checkout application 134.

During the checkout, shopping list application 104 may check the shopping list to determine if there is any item available for purchase, or any product designated for purchase from the hardware store, but has not been purchased as in step 212 of FIG. 2. For example, shopping list application 104 determines that potting soil is available from the hardware store but is missing from the sales receipt. Shopping list application 104 may generate an alert to remind user 101 of the un-purchased items as in step 214 of FIG. 2. For example, display 310 shows an alert to remind user 101 to purchase potting soil. Alerts may be visual, vibrational, and/or audible. User 101 may select potting soil in display 310 to view product information on the selection of potting soil available from the hardware store. The product information may also display or contain checkout identification information such as the barcodes or the NFC IDs of the selection of potting soil products. If user 101 desires to purchase potting soil, user 101 may select a product on shopping list application 104 and scan its bar code or NFC ID to make the purchase first and then pick up the product later. Shopping list application 104 obtains product information on the purchased potting soil product from checkout application 134 and checks off potting soil from the shopping list. Shopping list application 104 turns off the alert to indicate that all items from the hardware store have been purchased. Shopping list application 104 may also generate a reminder for user 101 to pick up products that have been purchased but not yet picked up. User 101 may complete checkout and may pick up the purchased potting soil product from the store shelf. Thus, shopping list application 104 reminds user 101 about un-purchased items corresponding to products available from the seller and conveniently allows user 101 to complete purchase of forgotten items during checkout. At the completion of checkout, shopping list application 104 may organize the shopping list to display remaining un-purchased items on the shopping list. For example, display 312 shows milk, bread, and eggs as the remaining un-purchased items on the top of the shopping list and groups products purchased from the hardware store at the bottom.

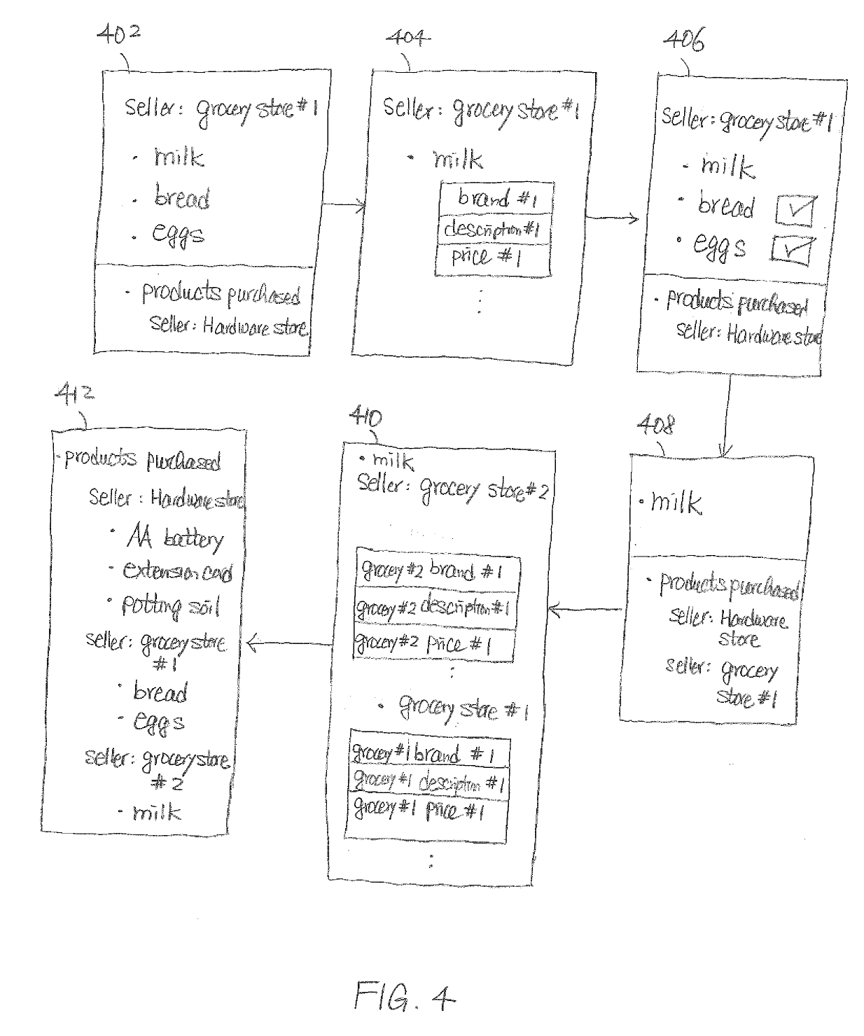

FIG. 4 shows a sequence of displays from the electronic shopping list application of FIG. 3 when a user makes product purchases at additional sellers according to one or more embodiments of the present disclosure. When user device 102 is within certain proximity of grocery store #1, shopping list application 104 queries seller inventory 132 of grocery store #1 for product information of the remaining items on the shopping list. Seller inventory 132 searches through its database of products and provides product information on milk, bread, eggs available for purchase from grocery store #1. Display 402 shows shopping list application 104 listing milk, bread, eggs under the grocery store #1 heading. User 101 may select an item under grocery store #1 to obtain detailed information on products matching the selected item. For example, if user 101 selects milk, display 404 shows brand, description, and price information for a selection of milk from grocery store #1. User 101 may decide to pick up a loaf of brad and a carton of eggs for checkout. As the loaf of bread and the carton of eggs are scanned and registered onto a sales receipt, shopping list application 104 may obtain information on these products from checkout application 134 of grocery store #1. Shopping list application 104 matches the loaf of bread and the carton of eggs with the corresponding items on the shopping list and checks off these items from the shopping list as purchased items as shown in display 406.

During checkout, shopping list application 104 determines that milk is available from grocery store #1 but is missing from the sales receipt. Shopping list application 104 may generate an alert to remind user 101 that milk was not purchased. However, user 101 may decide not to purchase milk from grocery store #1 and may proceed to complete checkout. After the completion of checkout, display 408 lists milk as the lone remaining un-purchased item on the top of the shopping list. Display 408 also groups products purchased from the hardware store and grocery store #1 at the bottom. User 101 may select the hardware store or grocery store #1 to view information on products purchased from these sellers.

User may go to grocery store #2. As user device 102 comes within certain proximity of grocery store #2, shopping list application 104 queries seller inventory 132 of grocery store #2 for product information of milk, the lone remaining item, on the shopping list. To compare milk products from grocery stores #1 and #2, user 101 may select milk on the shopping list to view product information of milk from both grocery stores. Display 410 shows brand, description, and price on the selections of milk available from grocery store #2 and grocery store #1. User 101 may decide to purchase a gallon of milk from grocery store #2 based on the product information and proceed to checkout. After the purchase of milk, all items on the shopping list have been purchased. Display 412 groups the purchased products under each of the three sellers for viewing by user 101.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as program code and/or data for managing and processing the items on the electronic shopping list, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

We claim:

1. A method comprising:
creating an electronic shopping list containing one or more items to purchase on a user device based on information received from a user;
determining one or more products selected by the user at a seller location;
comparing the products selected with the items on the electronic shopping list to determine items that are selected on the electronic shopping list; and
alerting the user of any items that are not selected on the electronic shopping list.

2. The method of claim 1, wherein the determining comprises:
obtaining product information of products that are available at the seller location to update the electronic shopping list, wherein the available products match one of the items on the electronic shopping list: and
receiving identifying information of the products selected among the available products.

3. The method of claim 2, wherein the determining further comprises:
detecting that the user device is in the vicinity of the seller location; and
querying the seller location for the product information of the available products.

4. The method of claim 2, wherein the determining further comprises:
detecting that the user belongs to a loyalty program; and
querying the seller location for preferred pricing information of the available products.

5. The method of claim 2, wherein the product information of the available products comprises brand, description, and price of the available products.

6. The method of claim 2, wherein the determining comprises obtaining the product information from a plurality of seller locations to update the electronic shopping list.

7. The method of claim 1, wherein the comparing comprises:
receiving product information of the selected products; and
identifying the items that are selected on the electronic shopping list from the product information.

8. The method of claim 7, wherein the comparing further comprises determining if there is at least one remaining item on the electronic shopping list with one or more matching products available at the seller location, and the alerting comprises alerting the user of the remaining item.

9. The method of claim 8, wherein the comparing further comprises displaying identification information of the one or more products matching the remaining item on the electronic shopping list to facilitate selection of the one or more products by the user.

10. The method of claim 8, wherein the comparing further comprises receiving product information of an additional selected product matching the remaining item on the electronic shopping list to update the items that are selected on the electronic shopping list.

11. The method of claim 7, wherein the product information of the selected products is received when the selected products are purchased at a checkout process.

12. The method of claim 7, wherein the product information of the selected products is received when the selected products are identified prior to a checkout process.

13. The method of claim 1, further comprising displaying product information of products that match the items on the electronic shopping list at one or more seller locations.

14. A user device comprising:
a processor; and
a memory adapted to store a plurality of machine-readable instructions which when executed by the processor are adapted to cause the user device to run a shopping list application to:
create an electronic shopping list containing one or more items to purchase based on information received from a user;
determine one or more products selected by the user at a seller location;
compare the products selected with the items on the electronic shopping list to determine items that are selected on the electronic shopping list; and
alert the user of any items that are not selected on the electronic shopping list.

15. The user device of claim 14, wherein the machine-readable instructions when executed by the processor are adapted to further cause the shopping list application to obtain, through a product query interface, product information of products that are available at the seller location to update the electronic shopping list, wherein the available products match one of the items on the electronic shopping list.

16. The user device of claim 15, wherein the machine-readable instructions when executed by the processor are adapted to further cause the shopping list application to detect that the user device is in the vicinity of the seller location and to query the seller location for the product information of the available products.

17. The user device of claim 14, wherein the machine-readable instructions when executed by the processor are adapted to further cause the shopping list application to receive product information of the selected products and to identify the items that are selected on the electronic shopping list from the product information.

18. The user device of claim 14, wherein the machine-readable instructions when executed by the processor are adapted to further cause the checkout interface to determine if there is at least one remaining item on the electronic shopping list with one or more matching products available at the seller location and to alert the user of the remaining item.

19. The user device of claim 18, wherein the machine-readable instructions when executed by the processor are adapted to further cause the checkout interface to display identification information of the one or more products matching the remaining item on the electronic shopping list to facilitate selection of the one or more products by the user.

20. A non-transitory computer readable medium having computer readable code for instructing a processor to perform a method, the method comprising:
creating an electronic shopping list containing one or more items to purchase based on information received from a user;
determining one or more products selected by the user at a seller location;
comparing the products selected with the items on the electronic shopping list to determine items that are selected on the electronic shopping list; and
alerting the user of any items that are not selected on the electronic shopping list.
